(19) United States
(12) Patent Application Publication
(10) Pub. No.: US 2021/0142646 A1
(43) Pub. Date: May 13, 2021

(54) COMMUNICATING BETWEEN A CONTROL UNIT AND A HAZARD SENSOR

(71) Applicant: Wearable Technology Limited, Leicester (GB)

(72) Inventor: Neil John CARTER, Nuneaton (GB)

(21) Appl. No.: 17/097,038

(22) Filed: Nov. 13, 2020

(30) Foreign Application Priority Data
Nov. 13, 2019 (GB) 1916556.2

(51) Int. Cl. G08B 21/16; H01B 11/02; A41D 1/00

(52) U.S. Cl. CPC G08B 21/16; A41D 1/005; H01B 11/02

(57) ABSTRACT

An apparatus for use in hazardous environments consists of an item of clothing, a control unit 213 and a hazard sensor 215. The item of clothing includes a loom 201 of conducting cables connected to peripheral device connectors 211, 212 for data transmission in accordance with a loom protocol. The control unit is connected to the loom and communicates with the hazard sensor over the loom. The hazard sensor has a hazard sensing device 216, a loom connector 217 and an interface circuit 218, wherein the interface circuit is configured to receive hazard data from said hazard sensor in accordance with a hazard-sensor protocol and transmit said hazard data to said control unit in accordance with said loom protocol.

### CROSS REFERENCE TO RELATED APPLICATIONS

This application claims priority from United Kingdom patent application number 1916556.2, filed on Nov. 13, 2019, the whole contents of which are incorporated herein by reference.

### BACKGROUND OF THE INVENTION

The present invention relates to a loom for use in items of clothing for use in hazardous environments.

It is known to provide hazard sensors on items of clothing, typically for detecting dangerous gases, radiation or excessive sound levels etc. It is also known to provide communication devices and personal area networks within items of clothing, which facilitate the inclusion of warning devices and allows communication back to base stations etc.

However, the interfacing of hazard sensors with control units has proved problematic, creating a need to increase the sophistication of some devices and thereby an increase to their overall cost, while at the same time the environment is demanding a greater deployment of devices of this type, such that a reduction in cost is expected.

### BRIEF SUMMARY OF THE INVENTION

According to a first aspect of the invention, there is provided an apparatus for use in hazardous environments, comprising: an item of clothing;

a control unit; and a hazard sensor, wherein: said item of clothing includes a loom of conducting cables connected to a plurality of peripheral device connectors, for data transmission in accordance with a loom protocol; said control unit is connected to said loom and communicates with said hazard sensor over said loom; and said hazard sensor comprises a hazard sensing device; a loom connector and an interface circuit, wherein said interface circuit is configured to receive hazard data from said hazard sensor in accordance with a hazard-sensor protocol and transmit said hazard data to said control unit in accordance with said loom protocol.

In an embodiment, each said peripheral device connector attached to the loom presents a circular surface defining a plurality of concentric electrical connectors. The hazard sensing device may produce initial data that is compared against a reference to produce output data; and said reference is transferred to said hazard sensor from said control unit.

According to a second aspect of the present invention, there is provided a method of communicating between a control unit and a hazard sensor, wherein said control unit and said hazard sensor are attached to an item of clothing and said hazard sensor includes a hazard sensing device, comprising the steps of: transmitting hazard data from said hazard sensing device to a processor in accordance with a hazard-sensor protocol, wherein said processor is electrically connected to a loom connector; and transmitting hazard data from said processor to a control unit, via said loom connector and a peripheral device connector connected to a loom, wherein said hazard data is transmitted to said control unit in accordance with a loom protocol.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art.

Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 shows operatives working in a hazardous environment;

FIG. 2 shows a schematic representation of the apparatus identified in FIG. 1;

FIG. 3 shows a portion of the loom identified in FIG. 2;

FIG. 4 shows a cross-section of the loom portion identified in FIG. 3;

FIG. 5 shows an example of a peripheral device connector;

FIG. 6 shows a first circuit board for receiving the peripheral device connector identified in FIG. 5;

FIG. 7 shows the connection of a peripheral device connector to loom portions;

FIG. 8 shows an example of a loom connector;

FIG. 9 shows an interface circuit for interfacing between the loom connector of FIG. 8 and a hazard sensing device;

FIG. 10 shows the rear of the circuit identified in FIG. 9;

FIG. 11 shows an alternative item of clothing for receiving a control unit;

FIG. 12 shows the rear of a control unit;

FIG. 13 shows the control unit identified in FIG. 12 attached to the item of clothing identified in FIG. 11;

FIG. 14 shows operations performed by the control unit identified in FIG. 13;

FIG. 15 shows a memory map for memory contained within a microprocessor identified in FIG. 9; and

FIG. 16 shows an initial signal being compared against a reference to produce a hazard output signal.

### DETAILED DESCRIPTION OF EMBODIMENTS OF THE INVENTION

### FIG. 1

Operatives are shown in FIG. 1 working in a hazardous environment. Each operative wears an item of clothing, such as a jacket 101, that includes a control unit and a hazard sensor 102. In the example shown in FIG. 1, the control unit is retained within an internal pocket. The item of clothing includes a loom of conducting cables connected to a plurality of peripheral device connectors, for data transmission in accordance with a loom protocol. The control unit is connected to the loom and communicates with the hazard sensor 102. The hazard sensor has a hazard sensing device, a loom connector and an interface circuit. The interface circuit is configured to receive hazard data from the hazard sensor in accordance with a hazard sensor protocol and transmit the hazard data to the control unit in accordance with the loom protocol.

The item of clothing in FIG. 1 is a jacket but other items of clothing may be deployed, usually of a type worn on the upper torso. Thus, the item of clothing may take the form of a vest, of the type described with reference to FIG. 11, or a harness etc.

In this embodiment, the item of clothing also includes light-emitting devices 103 connected to the loom and configured to be illuminated in response to power and data received from the control unit, as described in U.S. Pat. No. 10,161,611 assigned to the present applicant.

Many types of hazard sensor may be deployed, with the many sensors of this type becoming available at substantially reduced costs by the deployment of micro-electro-mechanical systems (MEMS). This facilitates the deployment of substantially more detectors of this type within a particular environment.

Previously, specialist equipment may have been carried by a single operative who was then responsible for periodically checking hazard levels. However, it is becoming increasingly evident that with personal area networks and local area networks, it is possible to collect data from a much larger number of operatives, possibly all operatives, working within an environment. The individual sensors themselves may be less sensitive but the collection of substantially larger volumes of data in real-time enhances the overall effectiveness of hazard detection. However, it is also appreciated that the cost of sensors can be increased significantly if it becomes a requirement for them to be provided with interface devices, such as buttons and screens, along with dedicated communication devices.

Hazard sensors are available for producing data in response to detecting hazards that non-exclusively include gas, radiation, dust particles, sound, proximity to vehicles and proximity to other operatives.

In addition to the hazard detecting sensor 102, the apparatus of FIG. 1 also includes a non-hazard detecting peripheral device 104 that, non-exclusively, may be a radio device, a power storage device, a single image camera or a video camera. The functionality of device 104 may also change when the device is disconnected, as described in U.S. Pat. No. 10,311,712, assigned to the present applicant.

### FIG. 2

A schematic representation of the apparatus identified in FIG. 1 is shown in FIG. 2. The item of clothing 101 includes a loom 201 of conducting cables. These conducting cables are connected to peripheral device connectors, including a first peripheral device connector 211 and a second peripheral device connector 212. Data transmission occurs over the loom in accordance with a loom protocol. The loom protocol is based around established I-squared-C protocols and facilitates the generation of data for activating LED devices, such as devices 103. A control unit 213 is connected to the loom 201 by means of a loom connector 214 that attaches to peripheral device connector 212. A hazard sensor 215 has a hazard sensing device 216, a loom connector 217 and an interface circuit 218. The interface circuit 218 is configured to receive hazard data from the hazard sensor 216 in accordance with a hazard-sensor protocol. This hazard data is then transmitted to the control unit in accordance with the loom protocol.

### FIG. 3

A portion of loom 201 is shown in FIG. 3. A first conductor 301 and a second conductor 302 are twisted together to form a first twisted pair 303. In addition, a third conductor 313 and a fourth conductor 314 form a second twisted pair 315.

A woven material 316 surrounds the first twisted pair 303 and the second twisted pair 315. A line of stitching 317 is applied between the first twisted pair 303 and the second twisted pair 315. This ensures that the two twisted pairs are separated and retained within their own respective conduits.

### FIG. 4

A cross-section of the loom portion 201 is shown in FIG. 4. The first twisted pair is held within a first conduit 401, with the second twisted pair being retained within a similar second conduit 402. Each conductor, such as the first conductor 301, includes a conducting inner core 403 and a surrounding insulator 404. In an embodiment, the surrounding insulator 404 is formed from a silicone rubber that is capable of being washed at relatively high temperatures, typically above 80° C.

The woven material 316 allows a degree of flexibility to facilitate deployment of the loom within an item of clothing. However, it is also resilient to ensure that the cables contained therein cannot penetrate the outer surface of the loom. Furthermore, it is not possible for the cables to form loops, which can then create positions of weakness and failure.

In an embodiment, the fabric material 316 includes electrically conductive threads 411 to provide electrical isolation to facilitate operation within environments that may include explosive gases. In an embodiment, the fabric material is woven such as to include warp threads and weft threads. In an embodiment, the conductive threads are included within the weft.

The woven material is brought together at each end to form a first securing tab 421 and a second securing tab 422. These securing tabs allow the loom to be secured, possibly by stitching, to the item of clothing. One of the securing tabs may be color coded to distinguish the two twisted pairs. This ensures that a twisted pair for carrying data can be distinguished from a twisted pair carrying power.

For the twisted pair carrying data, a degree of noise cancellation may occur, due to the cancellation of induced currents. The twisting is also advantageous in terms of significantly improving mechanical integrity and preventing the formation of loops.

### FIG. 5

Peripheral device connector 211 is shown in FIG. 5. The peripheral device connector is configured to provide a mechanically detachable electric interface for equipment that is supported on the external surface of an item of clothing. The connector may be a freedom LP360 type device available from Fischer Connectors of Saint-Prex Switzerland.

The connector 211 includes a rigid component 501 that is configured to extend externally through an orifice defined in an item of clothing. In addition, the connector 501 also includes an internal electrical interface portion 502.

### FIG. 6

A first circuit board 601 is shown in FIG. 6, for supporting a peripheral device connector of the type described with respect to FIG. 5. The first circuit board 601 includes first contacts 611 that are attachable to the internal electrical interface portion 502 of the peripheral device connector. The first contacts 611 are electrically connected to a first set of loom connectors 621 and a second set of loom connectors 622.

### FIG. 7

The first contacts 611 of a first circuit board 601 receive the electrical interface wires 502 of a peripheral device connector. Loom wires of a first loom portion are soldered to the first set of contacts contact 621, with the similar loom wires of a second loom portion being soldered to the second contact 622.

The combination of the first circuit board, a peripheral device connector, an end of a first loom portion and an end of a second loom portion are over moulded in rubber to provide a rubber cover 701. Cover 701 includes a first strain relief portion 702 and a second strain relief portion 703. The cover 701 also includes a first side flange 704 and a second side flange 705, to facilitate attachment of the cover to a garment, as described in GB 2569816 assigned to the present applicant.

The rigid component 501 of the peripheral device connector 211 extends through an orifice 706 in the rubber cover. In an embodiment, an outer cover 707 is also provided that includes a similar orifice 708. The peripheral device connector presents a circular surface 711 which, when deployed, lies substantially parallel with the outer surface of the garment. The circular surface includes a plurality of concentric electrical connectors to provide electrical connection to loom connectors, such as the type described with reference to FIG. 8, each attached to a peripheral device.

### FIG. 8

Loom connector 217 is shown in FIG. 8, that is configured to mechanically attach to a peripheral device connector, such as peripheral device connector 211. In addition to providing a mechanical attachment, an electrical interface is also defined by a first electrical contact 801, a second electrical contact 802, a third electrical contact 803, and a fourth electrical contact 804. These electrical contacts 801 to 804 are arranged so as to make contact with a respective circular electrode defined on circular surface 711. Thus, in this way, it is possible for a loom connector to rotate relatively to a peripheral device connector while still retaining electrical contact.

A ribbon cable 811 connects electrical contacts 801 to 804 to a zero-insertion-force (ZIF) plug 812. This in turn allows the loom connector 217 to be electrically connected to the interface circuit 218.

### FIG. 9

Interface circuit 218 is shown in FIG. 9. A microprocessor 901 has built-in interfaces, including an I-squared-C interface that interfaces with the garment loom, as described with reference to FIG. 10. The microprocessor 901 also has a second, I-squared-C interface and an SPI interface (serial peripheral interface) also known as a four-wire serial bus. In addition, the microprocessor provides a universal asynchronous receiver/transmitter interface (UART) allowing it to receive serial data streams following many established protocols.

An input/output port is provided for interfacing with sensor devices that raise a signal when an alert is identified. The microprocessor 901 is also provided with an analog-to-digital converter, allowing the processor to interface with analog outputs. Thus, in this way, it is possible for any available output from a sensing device to be translated by the microprocessor 901 and then put out onto the loom in accordance with the loom protocol.

The interface circuit 218 also allows power to be passed from the loom to the sensing device. Protection circuitry on the device may also receive power in this way.

A first hole 911 and a second hole 912 align with earth pins on the loom connector 217 to provide a secure connection to the loom connector. Electrical connection is then made by means of a ZIF connector, described with reference to FIG. 10.

The upper surface of the interface circuit shown in FIG. 9 includes a plurality of solder pads 915. Serial interfaces from the microprocessor 901 are connected to respective solder pads 915. During the assembly of the sensor 215, appropriate connections are made between the sensing device 216 and the appropriate solder pads 915.

The interface circuit 218 shown in FIG. 9 includes a board extension portion 921. The board extension portion 921 includes a micro USB socket 922 that is used to transfer executable instructions and data to the microprocessor 901. After being programmed in this way, the board extension 921 is snapped off, thereby reducing the overall size of the interface circuit to facilitate inclusion within the interface assembly 215.

### FIG. 10

The underside of interface circuit 218 is shown in FIG. 10. The board extension has been removed. A ZIF socket 1001 receives the ZIF plug 812, whereafter the underside of the interface circuit is physically secured to the loom connector 217.

### FIG. 11

As described with reference to FIG. 1, it is possible for a control unit (also referred to as a hub) to be retained within an internal pocket of a jacket, such as jacket 101, thereby providing a degree of mechanical protection. Alternatively, and particularly if regular monitoring is required, it is possible for a control unit to be mounted externally.

An item of clothing in the form of a vest 1101 is shown in FIG. 11. The vest is constructed from fluorescent material 1102 with light reflective strips, including a first light reflective strip 1103. A peripheral device connector 1104 extends from conductive strip 1103, with the twisted pairs of the wire loom 211 being retained behind. In this example, a subassembly 1105 of light-emitting diodes 1106 is also attached to the light reflective strip 1104 and electrically connected to the loom 201.

### FIG. 12

An example of a control unit 1201 is shown in FIG. 12. The rear surface of the control unit 1201 is shown in FIG. 12, exposing a loom connector 1211.

### FIG. 13

To secure the control unit shown in FIG. 12, the loom connector 1211 is attached to the peripheral device connector 1104, as shown in FIG. 13. In this configuration, an operative can activate the control unit by depressing a large control button 1301. In addition, an operative can view output indications provided by light-emitting diodes retained within a transparent enclosure 1302.

### FIG. 14

The embodiment provides for the performing of a method of communicating between a control unit and a hazard sensor, wherein the control unit and the hazard sensor are attached to an item of clothing and the hazard sensor includes a hazard sensing device. Hazard data is transmitted from the hazard sensing device 216 to processor 218 in accordance with a hazard sensor protocol. The processor 218 is electrically connected to a loom connector 217. Hazard data from the processor is transmitted to the control unit via the loom connector 217 and the peripheral device connector 211 connected to a loom 201. The hazard data is transmitted to the control unit in accordance with a loom protocol.

At step 1401 the control unit is activated and at step 1402 a question is asked as to whether a sensor has been detected. If answered in the negative, the process terminates. When answered in the affirmative, device type data is read at step 1403. In this way, the control unit 1201 is made aware of the type of device attached to the loom for which it is required to communicate with. In response to receiving this information, appropriate instructions are loaded at step 1404.

The sensor device 216 generates initial data that is compared against a reference in order to determine whether a hazard condition exists. Sensors of this type may have a predefined reference value which remains hardwired. Alternatively, it is possible for new reference values to be installed which, in known devices, may involve direct interaction with the sensor itself. However, present embodiment allows this threshold value to be adjusted dynamically.

Threshold data is sent to the peripheral device from the control unit at step 1405. In some embodiments, this reference data may remain constant and is reloaded during each deployment. Alternatively, the reference value may be selected in response to other conditions. Thus, an operative may be supplied with additional protective equipment, thereby allowing a higher threshold of the hazard to be present. Different reference values may also be selected in response to identifying whether an activity will take place indoors or outdoors for example.

At step 1406 hazard data is read, whereafter the procedure waits at step 1407 for more data to become available. In parallel with these activities, an assessment of data values may be made locally by the control unit. Alternatively, or in addition, hazard data may be relayed from the control unit to a base station. In this way, it is possible for alert conditions to be generated locally on the jacket or more widely within the working environment or wider still within an overall operation. Furthermore, the transmission of data of this type facilitates the establishment of historical records.

### FIG. 15

The processor 901 includes internal memory and a memory map 1501 is shown in FIG. 15. At locations 1502, executable instructions for the microprocessor 901 are stored and executed to achieve protocol conversion. Data is read from a sensor device and written to memory 1501 in a generalised way. Thus, irrespective of sensor type, the data goes into the same specified locations 1503. The method therefore writes hazard data to a first data storage area 1503 of the processor 901, whereafter the control unit is prompted to read this hazard data from the same first data storage area. Thus, the writing of data by the sensing devices is illustrated by a first arrow 1511, with the reading of the hazard data by the hub or control unit being indicated by a second arrow 1512.

Device type data, read at step 1403 by the control unit, is stored in a third memory location 1513. The reading of this data by the hub is indicated by a third arrow 1514.

In an embodiment, the control unit writes threshold data to the third data storage area 1515, as indicated by arrow 1516. The hazard sensing device then reads this stored reference data, as indicated by a fourth arrow 1517. The hazard sensing device produces detection data and compares this detection data against the threshold data read from memory, to produce the hazard data which is then subsequently written to the first data storage area 1503.

### FIG. 16

An example of an initial signal 1601 is illustrated in FIG. 16. The initial signal 1601 is compared against a threshold level 1602 which, in known devices, would be pre-programmed within the peripheral device itself.

In this embodiment, the threshold level 1602 has been read from the first memory area 1515 of the microprocessor 901 and is thereafter retained by the sensing device.

Within the sensing device itself, a comparator 1604 compares an incoming initial signal on an input line 1605 with the threshold value read from local storage 1606, to produce a hazard data output on an output line 1607.

A further example of an initial signal 1621 is also shown in FIG. 16. Adopting the approach described above, the threshold level may be adjusted from a minimum value 1622 to a maximum value 1623, as illustrated by arrow 1624, in response to receiving the threshold data from the first data storage area 1515. Thus, the initial signal 1621 will produce an alarm signal or will not produce an alarm signal dependent upon the actual level of the threshold read from local storage location 1606.

What we claim is:

1. An apparatus for use in hazardous environments, comprising:
an item of clothing;
a control unit; and
a hazard sensor, wherein:
said item of clothing comprises a loom of conducting cables connected to a plurality of peripheral device connectors for data transmission in accordance with a loom protocol;
said control unit is connected to said loom and communicates with said hazard sensor over said loom; and
said hazard sensor comprises a hazard sensing device; a loom connector and an interface circuit, wherein said interface circuit is configured to receive hazard data from said hazard sensor in accordance with a hazard-sensor protocol and transmit said hazard data to said control unit in accordance with said loom protocol.

2. The apparatus of claim 1, wherein:
said item of clothing is configured to be worn on an upper torso of an operative; and
said item of clothing comprises light-emitting devices connected to said loom and configured to be illuminated in response to power and data received from said control unit.

3. The apparatus of claim 1, wherein said hazard sensor produces data in response to detecting hazards that non-exclusively comprises at least one of gas, radiation, dust particles, sound, proximity to a vehicle or proximity to another operative.

4. The apparatus of claim 1, comprising a non-hazard detecting peripheral device for connection to said loom that non-exclusively comprises at least one of a radio device, a power storage device, a single image camera or a video camera.

5. The apparatus of claim 1, wherein said loom comprises:
a first conducting cable and a second conducting cable twisted together to form a first twisted pair;
a third conducting cable and a fourth conducting cable twisted together to form a second twisted pair; and
a fabric material surrounding said first twisted pair and said second twisted pair.

6. The apparatus of claim 5, wherein said first twisted pair and said second twisted pair are separated by a line of stitching.

7. The apparatus of claim 5, wherein said fabric material comprises electrically conductive threads to provide electrical isolation to facilitate operation within environments that may comprise explosive gases.

8. The apparatus of claim 7, wherein:
said fabric material is a woven fabric with a warp and a weft; and
said electrically conductive threads are comprised in said weft.

9. The apparatus of claim 1, wherein each peripheral device connector said plurality of peripheral device connectors connected to said loom presents a circular surface defining a plurality of concentric electrical connectors.

10. The apparatus of claim 1, wherein said hazard sensing device produces initial data that is compared against a reference to produce output data; and
said reference is transferred to said hazard sensor from said control unit.

11. The apparatus of claim 1, wherein:
said interface circuit is mounted on a circuit board; and
said circuit board comprises an internal connector for connection to an internal interface of said loom connector.

12. The apparatus of claim 11, wherein said circuit board comprises a plurality of interface communication pads to facilitate connection of said hazard sensing device to an appropriate interface of said interface circuit.

13. A method of communicating between a control unit and a hazard sensor, wherein said control unit and said hazard sensor are attached to an item of clothing and said hazard sensor comprises a hazard sensing device, comprising the steps of:
transmitting hazard data from said hazard sensing device to a processor in accordance with a hazard-sensor protocol, wherein said processor is electrically connected to a loom connector; and
transmitting said hazard data from said processor to a control unit via said loom connector and a peripheral device connector connected to a loom, wherein
said hazard data is transmitted to said control unit in accordance with a loom protocol.

14. The method of claim 13, further comprising the steps of:
writing said hazard data to a first data storage area of said processor; and
prompting said control unit to read said hazard data from said first data storage area.

15. The method of claim 13, further comprising the step of initiating a data communication, during which said control unit reads hazard sensing device type data from a second data storage area of said processor.

16. The method of claim 13, wherein:
said control unit writes reference data to a third data storage area of said processor; and
said hazard sensing device:
reads said reference data;
produces detection data; and
compares said detection data against said reference data to produce said hazard data.

17. The method of claim 13, wherein said step of transmitting said hazard data comprises transmitting said hazard data over said loom, said loom having a first twisted pair of cables and a second twisted pair of cables surrounded by a fabric material.

18. The method of claim 17, further comprising the step of transmitting said hazard data in an environment containing an explosive atmosphere, wherein said fabric material comprises electrically conductive threads.

19. The method of claim 18, further comprising the step of weaving said fabric material, such that said fabric material comprises a warp and a weft, wherein said electrically conductive threads are comprised in said weft.

20. The method of claim 13, wherein said step of transmitting said hazard data via said loom connector and said peripheral device connector comprises electrical transmission between pins extending from said loom connector that contact concentric electrodes defined by said peripheral device connector.
